(19) United States
(12) Patent Application Publication
(10) Pub. No.: US 2005/0251743 A1
(43) Pub. Date: Nov. 10, 2005

(54) Learning apparatus, program therefor and storage medium

(75) Inventors: Kyosuke Ishikawa, Minato-ku (JP); Masatoshi Tagawa, Ebina-shi (JP); Michihiro Tamune, Ashigarakami-gun (JP); Atsushi Itoh, Ashigarakami-gun (JP); Naoko Sato, Ebina-shi (JP); Kiyoshi Tashiro, Kawasaki-shi (JP); Hiroshi Masuichi, Ashigarakami-gun (JP); Shaoming Liu, Ashigarakami-gun (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/067,909

(22) Filed: Mar. 1, 2005

(30) Foreign Application Priority Data
May 10, 2004 (JP) 2004-139945

(51) Int. Cl. G06F 17/28

(52) U.S. Cl. 715/532

(57) ABSTRACT

In the learning apparatus, a memory stores a dictionary in an updatable manner, and an inputting means inputs data when an instruction is input by a user. An outputting part processes the data inputted through the inputting part by using the dictionary stored in the memory, and outputs the result of the processing. An identifier receiver obtains an identifier of the user or a group to which the user belongs. An updating means updates the dictionary only when the identifier obtained by the identifier receiver is pre-registered in the memory.

### BACKGROUND OF THE INVENTION

1. Field of the Invention

The present invention relates to a technology which processes inputted data to update a dictionary in a data processing system, and outputs the result.

2. Description of the Related Art

It is known to provide techniques for updating a dictionary by using inputted data. For example, it is known to provide a system is disclosed in which documents are inputted and classified or sorted. A document that is already classified is first inputted into the system. The document is then used to prepare a dictionary (learning data) in which document information and document classification probability are coordinated. Document information is information which includes words, or their relationships with their neighboring words. Document classification probability is a probability of the document information appearing in the document and belonging to a certain class or category. Then the inputted unclassified documents are processed so that the words are classified by using the prepared dictionary.

It is also known to provide a system in which a dictionary used for Japanese character conversion is shared and updated by plural users. In this system a dictionary stored in the server is shared by plural users and updated each time it is used. This system has a high level of learning efficiency.

In the above-described processing systems, in general, an optimal result can be obtained by a user using a dictionary specific to the requirements of a particular group, such as an organization or division to which the user belongs. Since it is difficult to prepare such a dictionary in advance, it is necessary for a user to contribute to a dictionary information specific to the requirements of the user's particular group, a so-called “learning” process, to help to obtain optimal results for the group. For the learning process to be effective, it is desirable that plural users share and contribute to the dictionary, so as to update it effectively.

Meanwhile, research is currently being carried out to determine whether copying machines or printers can be used to function as a processing system described above. Since users of such machines are not usually limited to members of a specific group, the constructed dictionary cannot always be specific to the requirements of a single group.

The present invention has been made in view of the above circumstances and provides a learning system and a program therefor to provide an effective dictionary updating technique.

### SUMMARY OF THE INVENTION

The present invention provides a learning apparatus furnished with: a memory that stores a dictionary in an updatable manner; an inputting part for inputting data via operation by a user; an outputting part that processes the data inputted through the inputting part by using the dictionary stored in the memory, and outputs the result of the processing; an identifier receiver for obtaining an identifier of the user or a group to which the user belongs; and an updating part for updating the dictionary only when the identifier obtained by the identifier receiver is registered in the memory in advance.

The present invention also provides a storage medium readable by a computer, the storage medium storing a program of instructions executable by the computer to perform a function, the function having: storing a dictionary in an updatable manner; inputting data when an instruction is input by a user; processing the inputted data by using the stored dictionary and outputting the result of the processing; obtaining an identifier of the user or a group to which the user belongs; and updating the dictionary only when the obtained identifier is pre-registered.

The above-described learning apparatus, and the computer executing the above-described program, respectively update the dictionary by using the inputted data only when the identifier of the user who inputted the data, or a group to which the user belongs, is registered in advance.

According to an embodiment of the present invention, by registering an identifier of a user or of a group to which the user belongs, a dictionary that is specific to the requirements of a particular group can be constructed so that it can be efficiently updated.

### BRIEF DESCRIPTION OF THE DRAWINGS

Embodiments of the present invention will be described in detail based on the following figures, wherein:

FIG. 1 illustrates a construction of the learning apparatus of an embodiment according to the present invention;

FIG. 2 schematically illustrates a data structure of Table T1 stored in the learning apparatus;

FIG. 3 schematically illustrates a content of registry list L stored in the learning apparatus;

FIG. 4 illustrates a flowchart of the user identification processing operation performed by the learning apparatus;

FIG. 5 illustrates a flowchart of the translation operation performed by the learning apparatus;

FIG. 6 illustrates an example of a document inputted into the learning apparatus;

FIG. 7 illustrates a flowchart of the data processing operation performed by the learning apparatus;

FIG. 8 schematically illustrates a content of Table T2 stored in the learning apparatus;

FIG. 9 illustrates an example of a document inputted into the learning apparatus;

FIG. 10 illustrates an example of a document formed by the learning apparatus; and

FIG. 11 illustrates an example of a document inputted into the learning apparatus.

### DETAILED DESCRIPTION OF THE INVENTION

An embodiment of the present invention will be described with reference to the attached drawings.

The embodiment is a machine translation apparatus to which the present invention is applied. The apparatus translates an inputted manuscript and outputs the result, and if the manuscript includes an abbreviation, which is not complemented by an original word, the apparatus processes the manuscript prior to translation so that the abbreviation is complemented by the original word. A table used for processing the manuscript is a dictionary to be updated by using the inputted manuscript.

[Construction]

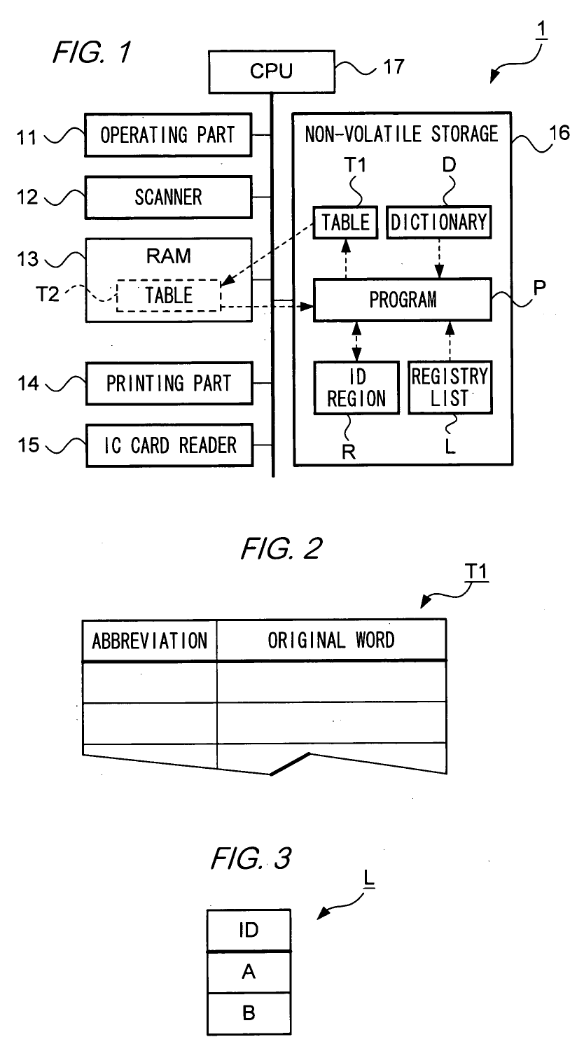

FIG. 1 illustrates a construction of the learning apparatus 1 according to the present invention. The learning apparatus 1 processes an inputted Japanese manuscript, translates it into English and outputs the translation. The apparatus comprises: an operating part 11 to be operated by a user for inputting a command; a scanner 12 for optically reading a manuscript set on a manuscript tray (not shown) of the learning apparatus 1 and outputting image data thereof; a RAM 13 for temporarily storing various data therein; a printing part 14 for forming on a paper an image of the image data stored in the RAM 13, and discharging the paper from the learning apparatus 1; an IC card reader 15 for detecting the state of the mount (mounted/demounted) of an IC card and reading out an ID or an identifier from the mounted IC card; a non-volatile storage 16 for storing data therein; and a CPU 17 for controlling the above mentioned parts.

The IC card to be mounted on the IC card reader 15 is delivered to every user using the learning apparatus 1 and stores an ID specific to the user. For example, user A has an IC card storing ID “A”, user B has an IC card storing ID “B”, and user C has an IC card storing ID “C”. In this example, users A and B belong to the same group and user C does not belong to the group.

The non-volatile storage 16 can store data without power being supplied from a power source, which is not illustrated, and stores a program P, which governs the following operations which are described hereafter; a translation dictionary D containing Japanese words and English words which are associated with each other; and a table T1 and a registry list L. The non-volatile storage 16 also reserves therein an ID region R for storing the written ID.

FIG. 2 schematically illustrates data structure of the table T1. The table T1 is for storing learning data necessary for processing documents. The learning data consists of pairs, each pair consisting of an abbreviation and an original word (Japanese), which are coordinated with each other. Each abbreviation is specific to a pair, and no two pairs include the same abbreviation. Though the table T1 can store plural pairs, no pairs are stored initially.

FIG. 3 schematically illustrates a content of the registry list L. The registry list L stores IDs of registered members, that is, users who belong to a group expected to specify the table T1. As shown here, IDs stored in the table T1 are “A” and “B” meaning that users A and B are the sole registered members.

The CPU 17 reads out the program P from the non-volatile storage 16 and executes the content of the program P, when power is supplied from a power source (not illustrated). By this step, the CPU 17 is ready to control the respective parts of the learning apparatus 1, and proceeds with the operations described hereafter. However, at an initial state of the following operations, it is assumed that no IC card is mounted on the IC card reader 15.

[Operation]

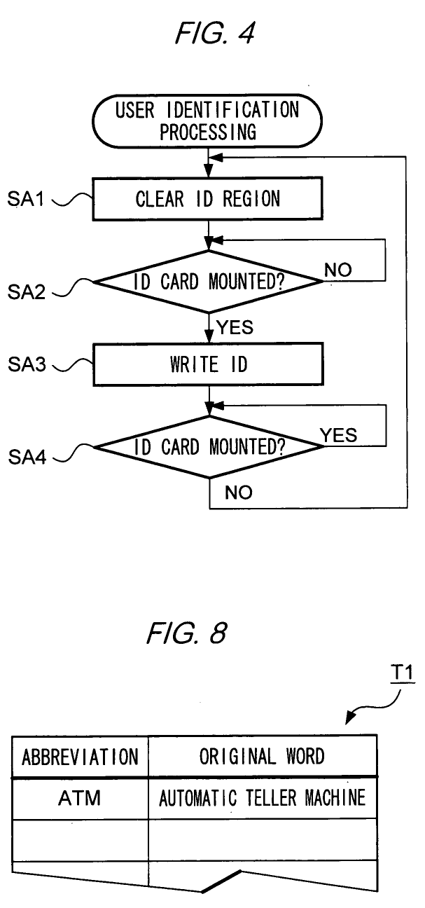

The CPU 17 executes a user identification process as shown in FIG. 4. At the start of the user identification process, the content stored in the ID region R of the non-volatile storage 16 is cleared (step SA1). Then a determination is made whether an IC card is mounted on the IC card reader 15 (step SA2). Specifically, the CPU 17 causes the IC card reader 15 to detect the state of mount of the IC card and makes the above determination. This determination is repeatedly executed until an IC card is mounted to the IC card reader 15 (step SA2: NO).

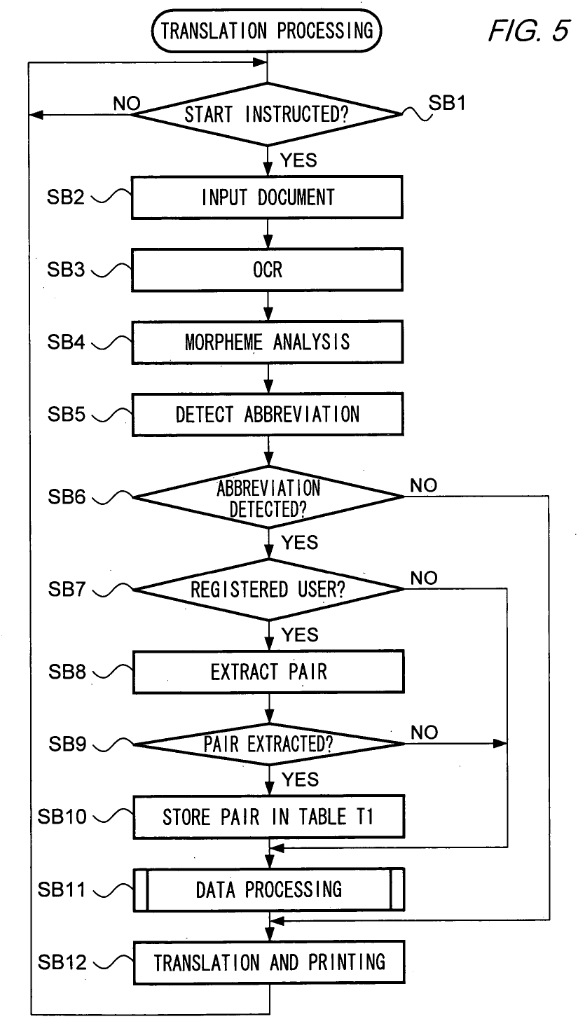

Assuming here that user A mounts his IC card to the ID card reader 15, then the result of the determination in the step SA2 is “YES”. Thus, the CPU 17 reads out ID “A” from the mounted IC card by the ID card reader 15 to write it on the ID region R, and, concurrently with the user identification process, starts a translation operation shown in FIG. 5 (step SA3). Then a determination is made as to whether an IC card is mounted to the ID card reader 15 (step SA4). This determination is repeated until the IC card is removed from the ID card reader 15 (step SA4: YES).

When processing translation as illustrated in FIG. 5, the CPU 17 first determines whether a starting command for starting translation is inputted through the operating part 11 (step SB 1). This determination is repeated until a starting command is inputted (step SB 1: NO).

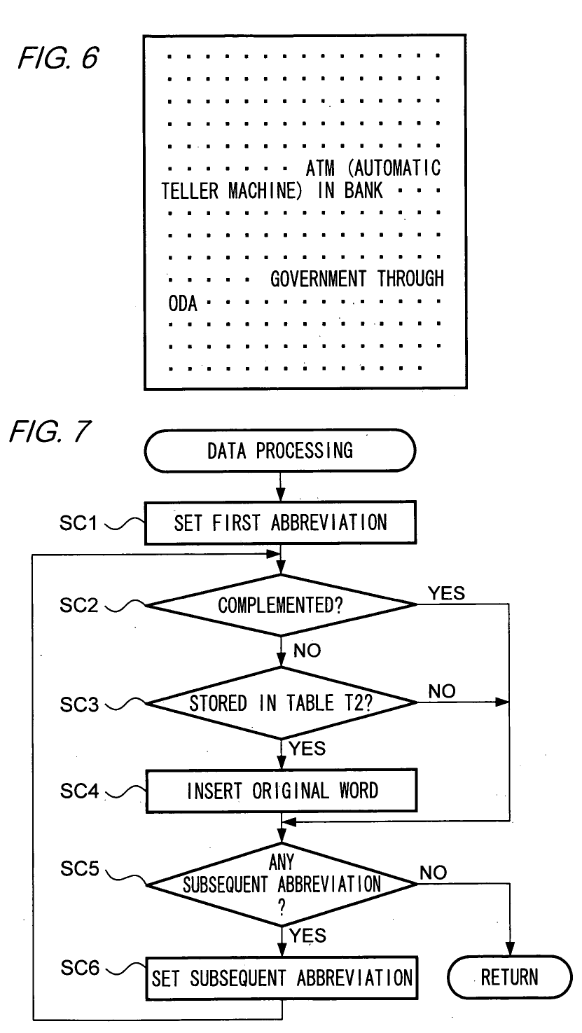

Assuming here that user A sets a Japanese manuscript including abbreviations “ATM” and “ODA” as shown in FIG. 6 on the manuscript tray, and inputs a starting command through the operating part 11, then the determination result in step SB1 becomes “YES”. Therefore, the CPU 17 optically reads the manuscript set on the tray, converts it into data of an image, and writes the image data on the RAM 13 (step SB2). Then the image data is subjected to an OCR (Optical Character Recognition) process to generate text data (step SB3), which is then subjected to a morphemic analysis (step SB4).

In the next step, abbreviations in the text are detected based on the result of the morphemic analysis and the content of the dictionary D (step SB5). More specifically, unidentified words are detected based on the results of the morphemic analysis, which are not registered in the dictionary D, and from among these unidentified words, those consisting of at least two capital letters are detected as abbreviations. Then a determination is made whether at least one abbreviation is detected (step SB6). In the embodiment, abbreviations “ATM” and “ODA” are detected; thus, the determination result is “YES”.

Thus, the CPU 17 determines whether the user is a registered member (step SB7). More specifically, a determination is made whether the ID in the ID region R is listed in the registry list L stored in the non-volatile storage 16. Here, ID “A” in the ID region R is listed in the registry list L; thus, the determination result is “YES”.

Thus, the CPU 17 reads out table T1 from the non-volatile storage 16 and writes it into the RAM 13, and also tries to extract a pair of words including the detected abbreviation from the text data (step SB8). More specifically, the CPU 17 determines whether there is a parenthesized word longer than the abbreviation at issue at a location immediately after the abbreviation. Only when there is, The CPU 17 deems the word to be the original word to complement the abbreviation, and extracts the abbreviation and the original word as a pair. Here, the detected abbreviations will be “ATM” and “ODA” alone, and “(automatic teller machine)” appears right after “ATM” while no parenthesized word appears right after “ODA”, so that “ATM” and “(automatic teller machine)” alone are extracted as a pair. In the following description, table T1 in the RAM 13 is designated as table T2 for the purpose of distinguishing it from the table T1 stored in the non-volatile storage 16.

Then the CPU 17 determines whether at least one pair, has been extracted (step SB9). Here, a pair consisting of “ATM” and “(automatic teller machine)” is extracted, so that determination result is “YES”. Thus, the CPU 17 stores the extracted pair in table T1 (step SB10) and the content of the table T1 is updated as shown in FIG. 8. If a pair including the same abbreviation, as the pair to be stored already exists in table T1, the CPU 17 overwrites the existing pair with the new pair to be stored.

Then the CPU 17 performs a data processing operation as shown in FIG. 7. In this process, from among the detected abbreviations, an abbreviation that is extracted first is selected as a target abbreviation to be processed (step SC1). Here, “ATM” will be the target abbreviation. Then a determination is made whether the target abbreviation is complemented by an original word (step SC2). That is, the CPU 17 determines whether there is a parenthesized word longer than the target abbreviation in the text data at a location immediately after the abbreviation. As is clear in FIG. 6, “ATM” is complemented by the original word so that the determination result is “YES”. Then the CPU 17 determines whether there is an abbreviation detected next to the target abbreviation (step SC5). Here, “ODA” is detected so that the determination result is “YES”. Therefore, the CPU 17 makes “ODA” the next target abbreviation to be processed (step SC6).

Then the CPU 17 determines whether the target abbreviation is complemented (step SC2). As is clear in FIG. 6, “ODA” is not complemented by the original word, so that the determination result is “NO”. Thus, the CPU 17 determines whether a pair including the target abbreviation is stored in table T2 (step SC3). Here, “ODA” is not stored in the table T2, so that the determination result is “NO”. Thus, the CPU 17 determines whether there is an abbreviation detected next to the target abbreviation (step SC5). No other abbreviation is detected next to “ODA”, so that the determination result is “NO”, and the processing is terminated without the text data being changed.

Then the CPU 17 translates the text data into English by using the result of the morphemic analysis and the dictionary D, writes image data of the translation result on the RAM 13, forms an image of the image data on a paper by using the printing part 14, and discharges the paper from the learning apparatus 1. Thus, an English translation document is outputted from the learning apparatus 1. After that, the CPU 17 waits for another start command to be input (step SB1: NO).

If user A removes his or her IC card from the IC card reader 15, then the determination result in step SA4 in FIG. 4 becomes “NO”. Thus, the CPU 17 clears the content stored in the ID region R and stops the translation in operation (step SA1). Thereafter, the CPU 17 continues to determine whether an IC card is mounted to the IC card reader 15 (step SA2: NO).

Here, if user B mounted his or her IC card to the IC card reader 15, then the determination result in step SA2 becomes “YES”. Thus, the CPU 17 reads ID “B” from the mounted IC card by the ID card reader 15 and writes it to the ID region R (step SA3), and starts a translation operation shown in FIG. 5 while identifying the user. Thereafter, the CPU 17 continues to determine whether an IC card is mounted to the IC card reader 15 (step SA4: YES).

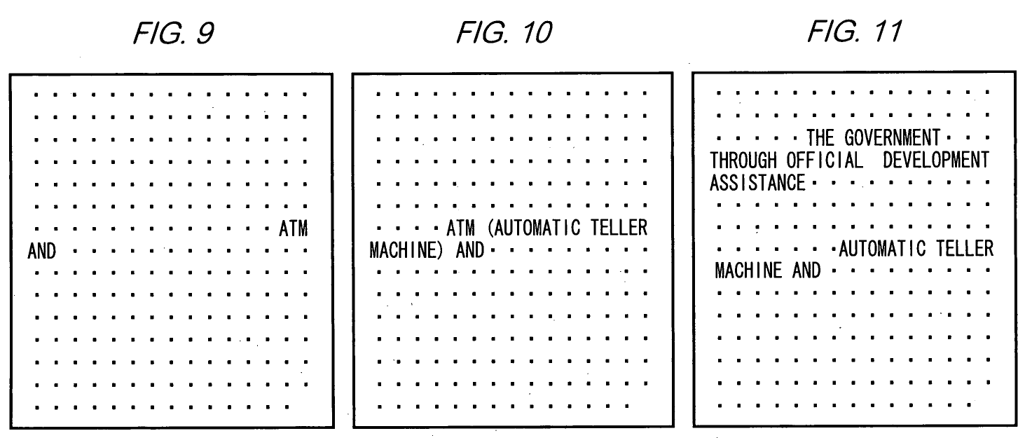

Here, if user B sets a Japanese manuscript (shown in FIG. 9) including a sole abbreviation “ATM” on the manuscript tray and inputs a start command through the operating part 11, then the determination result in step SB1 becomes “YES”. Thereafter, the same operations as described above are executed. However, since the sole abbreviation “ATM” is not complemented by the original word in the document shown in FIG. 9, as is clear in the figure, there is no pair extracted in step SB8. Thus, the determination result in step SB9 is “NO”, so that the CPU 17 does not store any pair in table T1 and performs a data processing operation (step SB 11).

In this data processing operation, the CPU 17 makes “ATM” a target abbreviation (step SC1), and determines whether the abbreviation is complemented by the original word (step SC2). As described above, “ATM” is not complemented by the original word, so that the determination result is “NO”. Then the CPU 17 determines whether a pair including “ATM” is stored in table T2 (step SC3). Here, the current content of table T2 is shown in FIG. 8. As is clear in this figure, a pair including “ATM” is already stored in table T2 so that the determination result is “YES”.

Therefore, the CPU 17 processes the text data of the document shown in FIG. 9 by inserting a character string (step SC4). This character string is formed by parenthesizing of the original word “automatic teller machine” included in the pair, and is inserted at a location right after “ATM” in the text data. As a result of the processing operation, the text data turns into a document shown in FIG. 10. Then the CPU 17 determines whether another abbreviation detected next to the targeted abbreviation exists (step SC5). Since no abbreviation is detected next to “ATM”, the result here is “NO”, and the processing is terminated.

Processes after this processing operation are the same as described above, and the CPU 17 waits for another start command to be input (step SB12, step SB1: NO).

Here, if user B has removed his or her IC card from the IC card reader 15, then the same processes as described above are performed, and the CPU 17 continues to determine whether an IC card is mounted to the IC card reader 15 (step SA4: NO, step SA1, step SA2: NO).

Here, if user C mounts his or her IC card to the IC card reader 15, then the same processes as described above are performed, and the CPU 17 continues to determine whether an IC card is mounted to the IC card reader 15 (step SA2: YES, step SA3, step SA4: YES). However, in this case, the ID to be written into the ID region R is “C”.

Here, if user C sets a manuscript shown in FIG. 9 on the manuscript tray and inputs a starting command through the operating part 11, then the determination result in step SB1 in FIG. 5 becomes “YES”. Thereafter, the same processes are performed as described above. However, in this process, ID “C” stored in the ID region R is not stored in the registry list L as illustrated in FIG. 3, so that the determination result in step SB7 is “NO”. Thus, the CPU 17 performs a data processing operation without trying to extract any pairs (step SB11).

In this data processing operation, the same processes are conducted as in the case of user B described above. As a result, a text data denoting the document shown in FIG. 10 is obtained and the data processing operation is terminated. Processes after this processing operation are the same as described above, and the CPU 17 waits for another start command to be input (step SB12, step SB11: NO).

Here, if user C has removed his or her IC card from the IC card reader 15, and user B has mounted his or her IC card to the IC card reader 15, ID “B” is written in the ID region R as a result. Assuming that user B sets a manuscript shown in FIG. 11 that does not include any abbreviations, and inputs a start command through the operating part 11, then the determination result in step SB6 in FIG. 5 becomes “NO”, and the CPU 17 performs the process of SB12 without determining whether user B is a registered member.

As described above, the CPU 17 of the learning apparatus 1 operates the scanner 12 to input manuscript, concurrently reads out table T1 from the non-volatile storage 16 and writes it to the RAM 13 as table T2. The CPU 17 then processes the inputted manuscript by using table T2, translates it by using dictionary D, and outputs the translation from the printing part 14. Meanwhile, the CPU 17 reads out and retrieves an ID from the IC card, and updates the table T1 by using the inputted manuscript only when the ID is stored in advance in the registry list L in the non-volatile storage 16.

That is, only when the manuscript is inputted by a user having an IC card storing an ID already stored in the registry list L, table T1 is updated by the manuscript. Therefore, without limiting the users to access the learning apparatus 1, the table T1 is positively and efficiently constructed to be specific to a group to which users A and B belong, thus making it usable for a data processing operation.

The above-described embodiments can be modified in the following manners.

The learning apparatus 1 can be constructed as a system comprised of plural devices.

Also, the learning apparatus 1 can be constructed so that it can perform the translation operation shown in FIG. 5 when an IC card is not mounted to the IC card reader 15. In this case, the sequence of steps should be amended so that, if an ID is not written in the ID region R, that is, the CPU 17 fails to retrieve the ID, the determination result in step SB7 becomes “NO”.

It is also possible to provide an organization table in which each member's ID is coordinated with the ID of the group, and to store it in the non-volatile storage 16 so that the CPU 17 can identify the group to which a user belongs by using the organization table. Also, a user can use an ID card storing the ID of a group to which s/he belongs, other than his or her ID card. In these cases, an ID(s) for the group which is allowed to update the dictionary D, is stored in the registry list L in advance.

Also, the learning apparatus 1 can be constructed as an apparatus used for performing other tasks than machine translation. For example, it can be constructed as an apparatus to update a characteristic value dictionary, which matches a characteristic value of a configuration of a letter with a letter in an OCR system. In this case, the characteristic value dictionary is updated when it has accomplished recognition of a letter with a high degree of accuracy. It is also possible to construct a learning apparatus to update a dictionary in any system that processes inputted data using the dictionary and to output the result, such as a system for sorting inputted documents or a system for converting Japanese characters. Needless to say, the form or method for the data input or data output can be optional. For example, data can be inputted or outputted by receiving or sending of electric signals.

If the invention is applied to a case such as Japanese character conversion, where a subject to be updated is determined based on both the inputted data to be converted and a command from the user, to select one of plural possible choices, it is desirable to confirm that the user (or group) who inputted the data is the registered user (or group) not only for the inputted data to be converted but also for the inputted data, in order to update the dictionary.

As described above, the learning apparatus or the program for operating the apparatus updates the dictionary in accordance with the inputted data only when the identifier of the user who inputted the data, or a group to which the user belongs, is registered in advance. Therefore, by registering an identifier of the user or of the group to which the user belongs, a dictionary can be efficiently constructed that is specific to the needs of a particular group.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, to thereby enable others skilled in the art to understand the invention with various embodiments and modifications as are suited to the particular use contemplated. It is intended that the scope of the invention be defined by the following claims and their equivalents.

The entire disclosure of Japanese Patent Application No. 2004-139945 filed on May 10, 2004 including specifications, claims, drawings and abstract is incorporated herein by reference in its entirety.

1. A learning apparatus comprising:
a memory that stores a dictionary in an updatable manner;
an inputting part that inputs data when an instruction is input by a user;
an outputting part that processes the data inputted through the inputting part by using the dictionary stored in the memory and outputs the result of the processing;
an identifier receiver that obtains an identifier of the user or a group to which the user belongs; and
an updating part that updates the dictionary only when the identifier obtained by the identifier receiver is pre-registered in the memory.

2. A storage medium readable by a computer, the storage medium storing a program of instructions executable by the computer to perform a function, the function comprising:
storing a dictionary in an updatable manner;
inputting data when an instruction is input by a user;
processing the inputted data by using the stored dictionary and outputting the result of the processing;
obtaining an identifier of the user or a group to which the user belongs; and
updating the dictionary only when the obtained identifier is pre-registered.
